(19) United States
(12) Patent Application Publication
(10) Pub. No.: US 2008/0243269 A1
(43) Pub. Date: Oct. 2, 2008

(54) Method and System for Scheduling Reinforcing Bars for Use in Reinforced Products

(75) Inventors: Heath Townsend, Queensland (AU); Peter Tremellen, Queensland (AU); Paul Miller, Queensland (AU); Patrick Young, Queensland (AU); Glenn Dickey, Queensland (AU); David Harris, Queensland (AU)

Correspondence Address: HARNESS, DICKEY & PIERCE, P.L.C., P.O. BOX 828, BLOOMFIELD HILLS, MI, 48303, US

(73) Assignee: The Australian Steel Company (Operations) Pty Ltd, Port Melbourne (AT)

(21) Appl. No.: 10/592,915

(22) PCT Filed: Mar. 21, 2005
(86) PCT No.: PCT/AU05/00404

§ 371 Date: Sep. 15, 2006

(30) Foreign Application Priority Data
Mar. 19, 2004 (AU) 2004901480

(51) Int. Cl. G05B 13/02

(52) U.S. Cl. 700/32; 700/99; 700/225

(57) ABSTRACT

An automated method of scheduling reinforcing bars for use in reinforced products, the method including the steps of: storing default reinforced product parameters in a database (14); in a database engine (12), automatically detecting (115) one or more reinforced product properties from one or more reinforced product drawings; and using the stored reinforced product parameters and detected reinforced product properties to generate (121) reinforcing bar scheduling data.

The present invention relates generally to the scheduling of reinforcing bars for use in reinforced products, and in particular to the automation of one or more activities undertaken during scheduling of the reinforcing bars. The present invention is suitable for use in the scheduling of reinforcing steel bars for use reinforced concrete products, and it will be convenient to describe the invention in relation to that application. It is to be appreciated however, that the invention is not limited to use in that application only.

The scheduling of steel bars for the reinforcement of concrete slabs and other products involves determining the shape, dimensions, quantity and spacing of steel bars that are used to reinforce concrete products. The scheduling process commences with the three dimensional form of the concrete structure to be reinforced. A draftsman then determines the desired placement of primary reinforcing steel bars and distribution steel bars throughout the concrete structure in accordance with design criteria for the concrete structure and building standards. Once the desired placement of the steel reinforcing bars has been determined, the shape, quantity and dimensions of the different reinforcing steel bars that are required are tabulated so that an order for the reinforcing steel bars can be placed.

The scheduling of reinforcing bars in concrete slabs is a highly manual process, and utilises approximately 60% of total scheduling resources in typical construction projects. Much of the scheduling process is repetitive and time consuming. Moreover, each time the design of one or more concrete structures in a construction project is altered, the scheduling process must be repeated so that much scheduling effort is lost;

Attempts have been made to improve the efficiency of reinforcing bar scheduling by the use of software tools. One existing software tool enables engineering drawings to be prepared in which the three dimensional form of concrete structures is shown. A draftsman can electronically position reinforcing steel bars within the electronic representations of the concrete structures generated by the software tools. When each reinforcing steel bar is electronically drawn, the software tool records the shape and specified dimensions of the reinforcing steel bar in order that a list of all reinforcing bars used in the design of the reinforced concrete structure can be generated. Whilst such a system improves the efficiency of a completely manual scheduling process, it is nevertheless inflexible and requires the software tool to be used during the entirety of the scheduling process. Such software tools are typically expensive and not in widespread use. Moreover, existing software tools are only able to be used when all of the steps involved in the scheduling of reinforcing steels bars are performed on the software tools themselves.

It would therefore be desirable to provide a method and system of scheduling reinforcing bars for use in reinforced products that ameliorate or overcome one or more disadvantages of known scheduling systems and methods.

It would also be desirable to provide a method and system of scheduling reinforcing bars for use in reinforced products that improve the efficiency of the scheduling process and are compatible for existing scheduling operations.

With this in mind, one aspect of the invention provides an automated method of scheduling reinforcing bars for use in reinforced products, the method including the steps of:

storing default reinforced product parameters in a database;

in a database engine, automatically detecting one or more reinforced. product properties from one or more reinforced product drawings; and

using the stored reinforced product parameters and detected reinforced product properties to generate reinforcing bar scheduling data.

The reinforced products may be reinforced concrete products, including any one or more of a concrete slab, beam, column, wall, stair, tilt panel, coupler, top hat, bar chair and laser bar.

The reinforced product properties may include any one or more of the outline of the reinforced product, the extent of the reinforced product and any penetrations of the reinforced product.

The reinforced product properties may include any steps in one of more surface of the reinforced product, including any visible and hidden steps in the reinforced product.

The reinforced product properties may include text characterising one or more of the reinforcing bars. For example, the text may characterise the dimensions of reinforcing bars and/or the spacing between reinforcing bars.

The reinforcing bar dimensions may include any one or more of shape, length and position within a layer of the reinforced product.

The reinforced product properties may include the shape of one or more of the reinforcing bars.

The reinforced product properties may include the extent of one or more ranges of the reinforcing bars.

The reinforcing bars may include primary reinforcing bars and/or secondary reinforcing bars, such as distribution steel.

The reinforced product properties may include data characterising the secondary reinforcing bars.

The reinforced product properties may include positions where one or more reinforcing bars overlap.

The reinforced product properties may include the gradient of one or more portions of the reinforced product.

The default reinforced product parameters may include the bottom and/or top cover of the reinforced product.

The default reinforced product parameters may include bar overlap lengths.

The default reinforced product parameters may include default bar shapes and/or dimensions.

The method may further include the step of:

selecting one or more zones within the one or more reinforced product drawings to carry out reinforcing bar scheduling.

Each zone may correspond to separately constructed portion of the reinforced product, for example a separately poured section of a reinforced concrete product.

The method may further include the step of:

at a display terminal, displaying the reinforcing bar scheduling data.

The method may further include the step of:

rationalising the reinforcing bars for use in the reinforced products.

The step of rationalising the reinforcing bars may include:

selecting reinforcing bars having dimensions within a predefined tolerance; and

re-labelling the selected reinforcing bars within the same dimensions on the reinforced product drawings.

The present invention provides a significant advance over existing scheduling products by enabling the production of reinforcement schedule data from existing drawings, such as electronic CAD files supplied by customers, by scanning existing line work. During the scanning process, concrete lines, section bars, bar ranges and text labels are identified to create duplicate dynamic details for the creation of marking plans along with other schedule data that is produced from a combination of scanning existing element data while also following a set of user defined rules.

Another aspect of the invention provides an automated system for scheduling reinforcing bars for use in reinforced products, the system including:

a database for storing default reinforced product parameters; and

a database engine for automatically detecting one or more reinforced product properties from one or more reinforced product drawings, wherein database engine uses the stored reinforced product parameters and detected reinforced product properties to generate reinforcing bar scheduling data.

Yet another aspect of the invention provides a computer program element for use in an automated system for scheduling reinforcing bars for use in reinforced products, the computer program element including a series of instructions for causing a database engine to:

automatically detect one or more reinforced product characteristics from one or more reinforced product drawings; and

use the reinforced product parameters stored in a database, and detected reinforced product properties, to generate reinforcing bar scheduling data.

The following description refers in more detail the various features of the invention. To facilitate and understand the invention reference is made in the description to the accompanying drawings where the method and system of the schedule reinforcing bars for use in reinforced products is illustrated in a preferred embodiment. It is to be understood that the invention is however not limited to the preferred embodiment as illustrated in the drawings.

In the drawings:

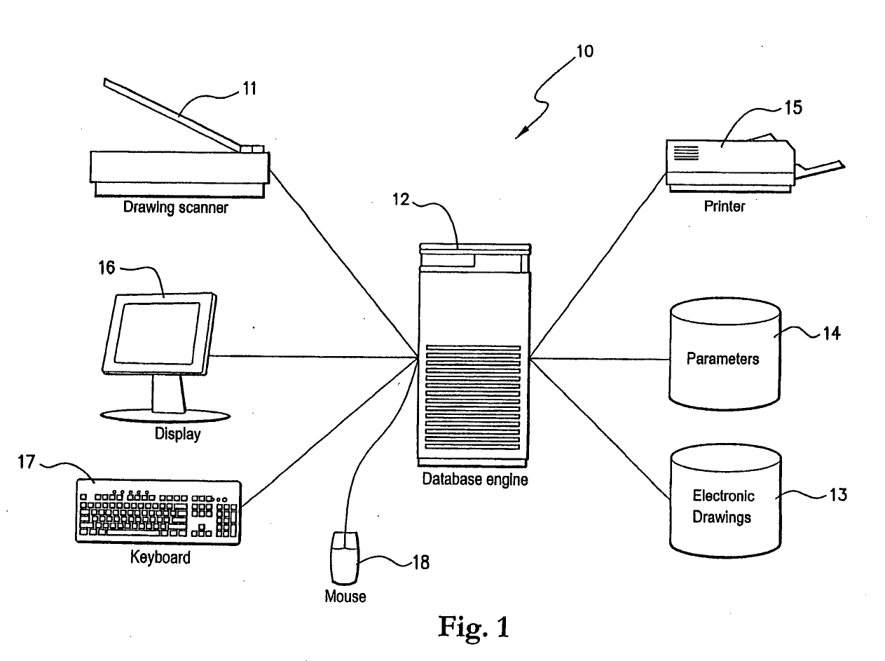

FIG. 1 is a schematic diagram illustrating one embodiment of a system for scheduling reinforcing bars for use in reinforced products in accordance with the present invention;

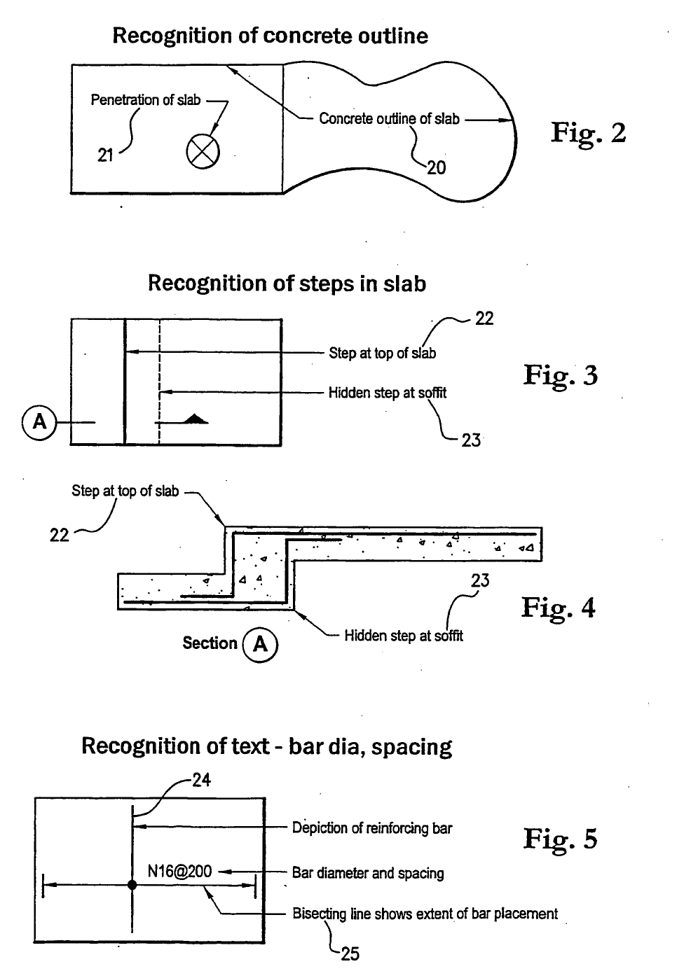

FIGS. 2 to 15 are exemplary engineering drawings illustrating various reinforced product characteristics read by the database engine forming part of the system of FIG. 1;

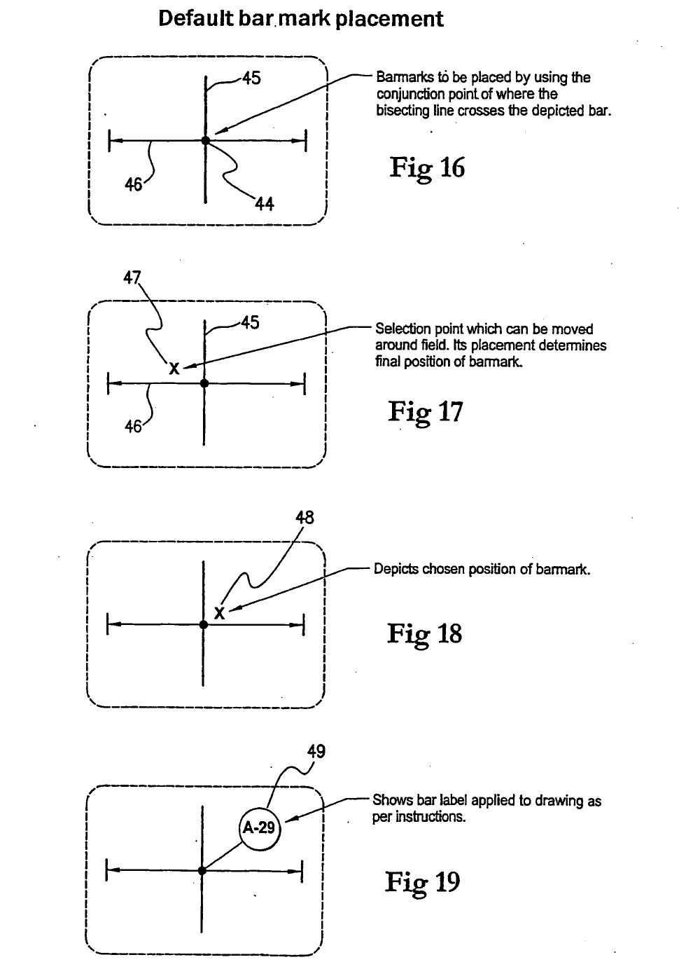

FIGS. 16 to 21 are exemplary engineering drawings showing bar marking steps performed by the database engine forming part of the system of FIG. 1;

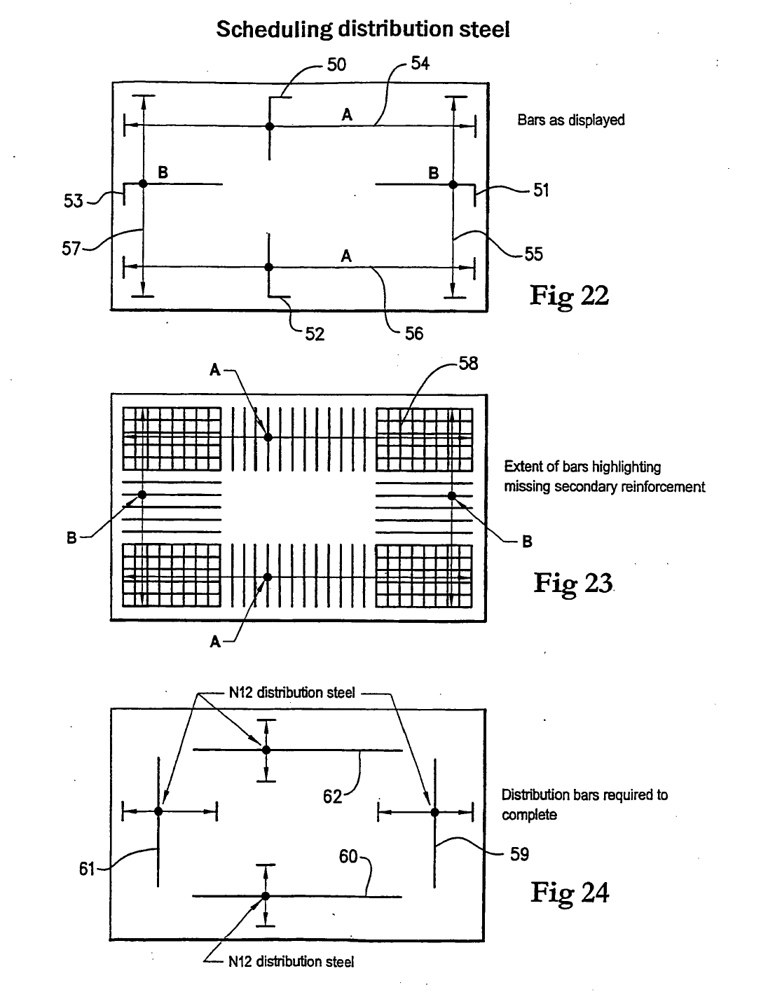

FIGS. 22 to 24 are exemplary engineering drawings showing steps performed by the database engine forming part of the system of FIG. 1 in the recognition and scheduling of distribution steel;

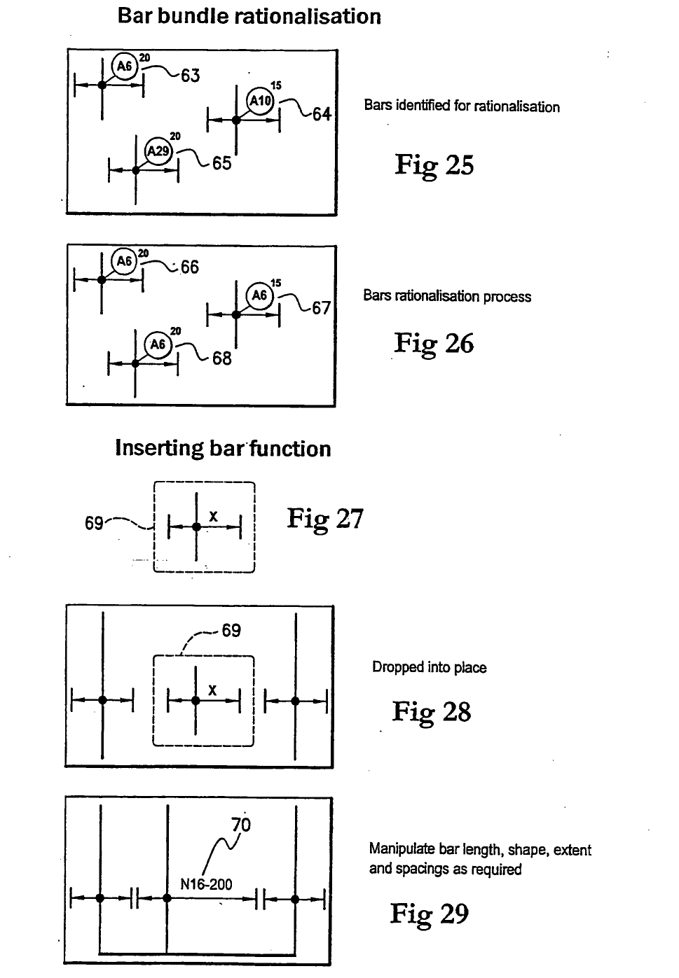

FIGS. 25 and 26 are exemplary engineering drawings showing steps performed by the database engine forming part of the system of FIG. 1 in bundle bar rationalisation;

FIGS. 27 to 29 are exemplary engineering drawings showing steps performed by the database engine forming part of the system of FIG. 1 in providing a bar insertion function;

FIGS. 30 and 33 are exemplary engineering drawings showing default reinforced product parameters used by the database engine forming part of the system of FIG. 1;

FIGS. 34 and 35 are exemplary engineering drawings showing separate zones of an engineering drawing separately scheduled by the database engine forming part of the system of FIG. 1;

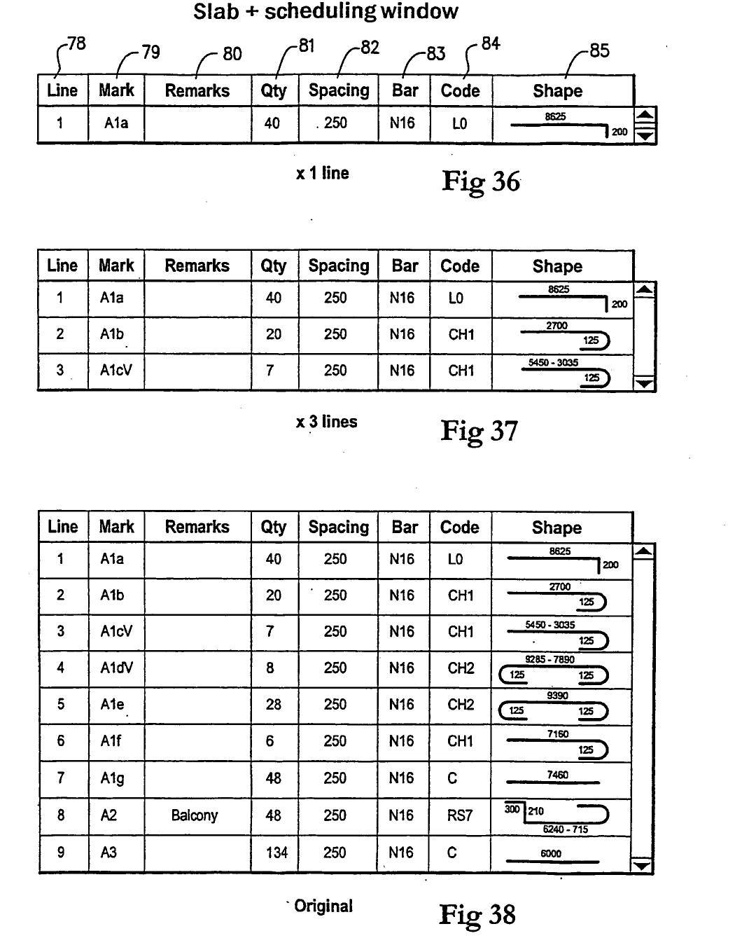

FIGS. 36 to 38 are exemplary displays showing reinforcing bar lists scheduled by the database engine forming part of the system of FIG. 1;

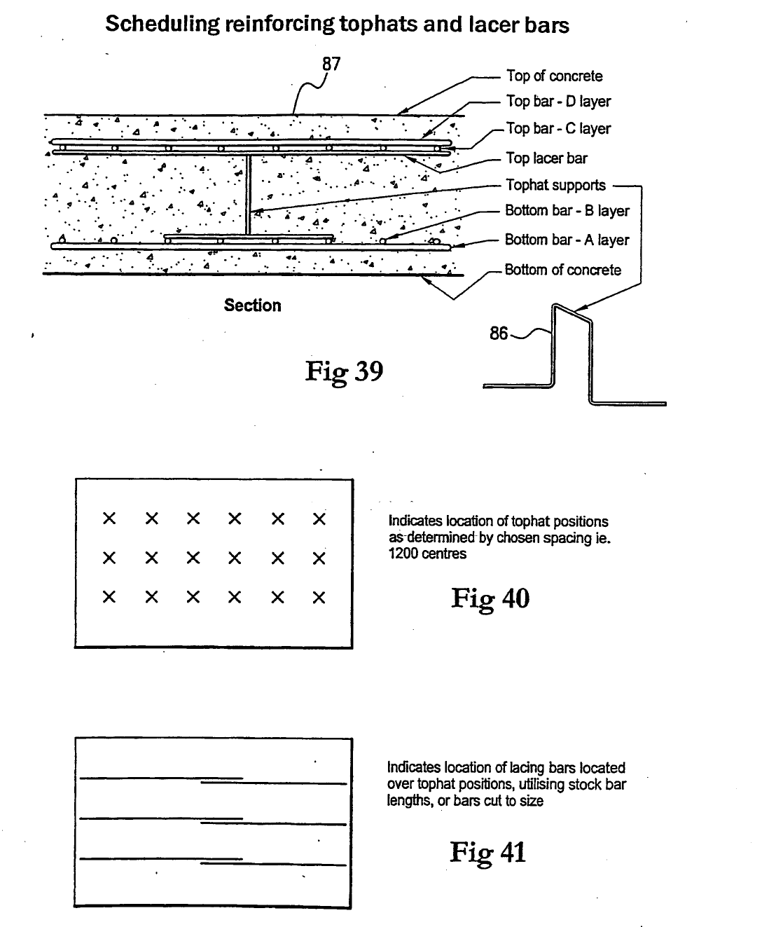

FIGS. 39 to 43 are exemplary engineering drawings illustrative of the scheduling of reinforcing accessories by the database engine forming part of the system of FIG. 1;

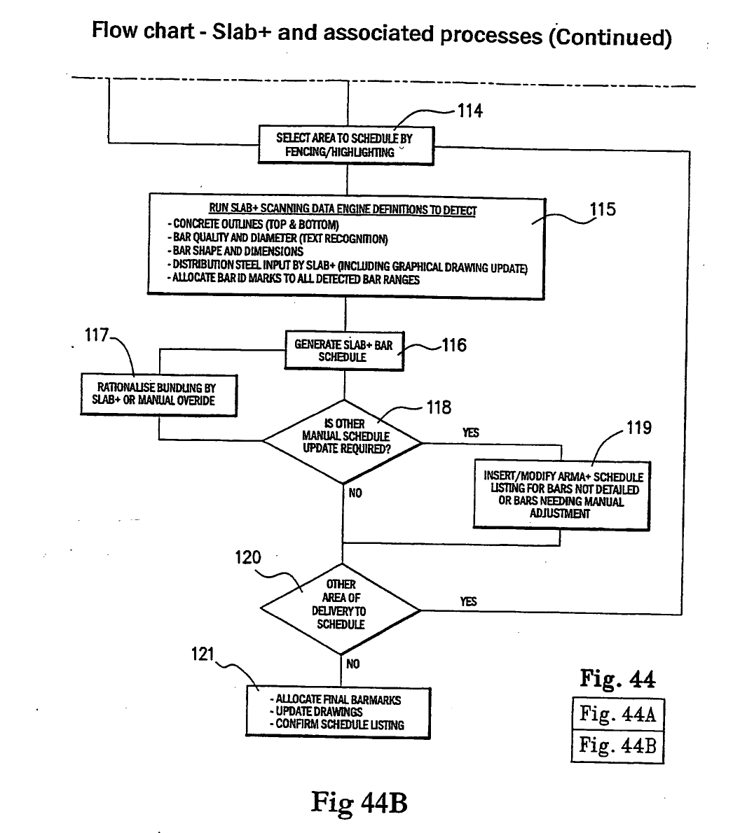

FIG. 44 is a flow chart showing steps performed by the system of FIG. 1 during the scheduling of reinforcing bars for use in reinforced products in accordance with one embodiment of the present invention; and

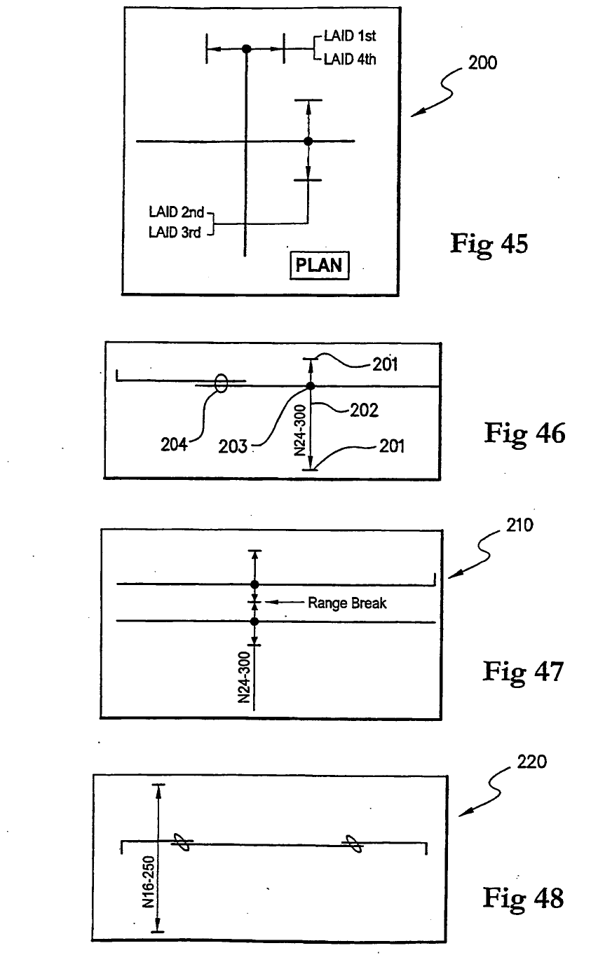

FIGS. 45 to 49 are exemplary screen displays presented to a user during operation of the system for scheduling reinforcing bars.

Referring now to FIG. 1 there is shown generally a system 10 for scheduling reinforcing bars for use in reinforced products. The system 10 includes a drawing scanner 11 for scanning engineering drawings of concrete products and the intended placement of reinforced steel bars within those concrete products. The system also includes a database engine 12 for detecting various properties of the reinforced products from the engineering drawings scanned by the drawing scanner 11. The database engine 12 accesses an electronic drawings database 13 and a parameters database 14. An electronic representation of the electronic drawings scanned by the drawings scanner 11 is maintained in the electronic drawings database 13. The parameters database 14 maintains various parameters characterising the reinforced concrete products depicted in the drawings maintained in the electronic drawings database 13. The database engine uses the stored product parameters maintained in the parameters database 14 and the detected reinforced product properties to generate reinforcing bar scheduling data. A report of the scheduling data may be generated by the database engine 12 and printed at the printer 15. Manual intervention by an operator with the database engine 12 is provided by the display 16, keyboard 17 and mouse 18.

The database engine 12 acts to “read” existing engineering drawings and recognise various properties of reinforced concrete products and reinforcing bars used in the concrete products for the purposes of scheduling. The existing drawings may be provided to the database engine 12 either by being scanned by the drawing scanner 11, or by being provided to the database engine 12 in electronic format. Typically, the electronic drawings may be provided in a .dwg or .dfx format compatible with most common applications, for example AutoCAD systems. Drawings in other formats are generally able to be converted. Vectorisation technology is applied when hard copies of the drawings are scanned by the drawing scanner 11 in order to derive an electronic engineering drawing for storage in the electronic drawings database 13 and subsequent use by the database engine 12.

The database engine 12 is adapted to read drawing intelligence and recognise a number of reinforced products properties from the engineering drawings. The reinforced product properties include the outline 20 of a concrete product, such as the shape of the slab, its extent and any penetrations 21, as seen in FIG. 2. The database engine is also adapted to address any shaped outline including circular, elliptical, angular or combinations of shapes. As seen in FIG. 3, the reinforced product properties also include visible steps 22 and hidden steps 23 in views of the concrete product. FIG. 4 shows a side view of the concrete product plan view shown in FIG. 3, in which the visible step 22 and hidden step 23 are more apparent.

The properties of relevant objects of an active electronic drawing are collected by the database engine 12 via a scanning process involving electronic examination and extraction of drawing objects and their properties. The captured drawing intelligence is filtered and manipulated by the database engine 12 which contains a number of preset and changeable parameters, including tables, defaults and settings. This in turn calculates, formulates and generates a resultant output for a workable, factual, numerical and actual representation of reinforcing bar data.

The properties may include named attributes of an object. Properties define object characteristics such as size, colour, and screen location, or the state of an object, such as enabled or disabled or a value such as true or false. An object represents an element of the application, such as a drawing, a cell, a line, a chart, a form, a report or a worksheet.

Extracted data maintains a dynamic link with the CAD elements within the CAD file and project default settings that are setup within the database. Data and CAD elements can be manipulated via a CAD interface (including but not limited to AutoCAD for example) and/or a Schedule window. Data and CAD elements will dynamically change as modifications are made. The schedule window allows further refinements, input, alteration, grouping and deletion workability. The CAD file and extracted data are stored in a library for future use.

The schedule window also allows this resultant output information to be altered and driven back into the drawing to change, manipulate or update the existing first gathered information.

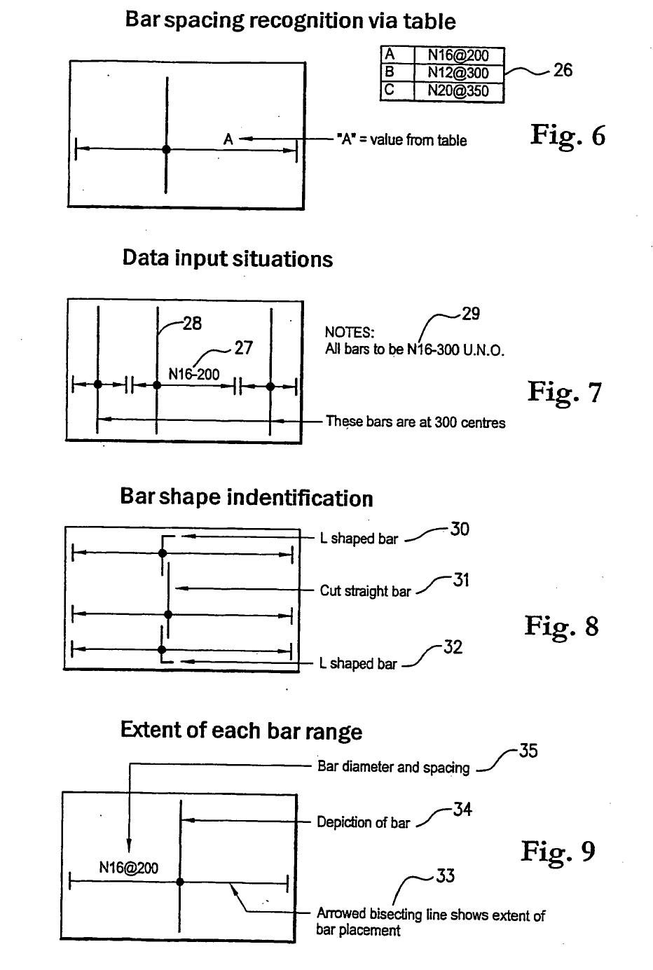

Another reinforced product property recognised by the database engine 12 is text characterising one or more of the reinforcing bars. For example, the text may characterise the dimensions of reinforcing bars and/or the spacing between reinforcing bars. An example is shown in FIG. 5, where the text “N16@200” indicates the individual diameter and spacing of reinforcing bars 24 to be used throughout the extent 25 of the concrete product. Another example of text characterising one or more of the reinforcing bars is shown in FIG. 6, which illustrates when an engineering drawing uses a table 26 to define the diameter and spacing of bars as an alternative to the more common textural representation such as “N16@200” illustrated in FIG. 5. In this example, an alphanumeric character is located physically proximate a reinforcing bar on the engineering drawing, and the specifications and spacing of those reinforcing bars are then associated with the alphanumeric identifier in the table 26.

Another example of text on an engineering drawings that characterises one or more of the reinforcing bars is illustrated in FIG. 7. In this Figure, a first text block 27 is located physically proximate a first bar 28 to indicate the dimensions and spacing of a first group of reinforcing bars in the concrete object. However, an second text block 29 indicates that all other bars in the engineering drawing are to have a different spacing.

The reinforced product properties recognised by the database engine 12 also include the shape of one or more of the reinforcing bars. An exemplary L-shaped bar 30, cut straight bar 31 and L-shaped bar 32 are illustrated in FIG. 8. The extent of one or more ranges of the reinforcing bars is another reinforced product property detected by the database engine 12. As shown in FIG. 9, the extent of each bar range is indicated by an arrowed line 33 projecting from either side of a depiction 34 of a reinforcing bar. A text block 35 is positioned on the drawing proximate the depiction of the bar 34 to indicate the bar diameter and spacing. The arrowed line 33 identifies the extent or coverage for each specific bar, and where it is to be placed throughout the slab in its specific layer and direction.

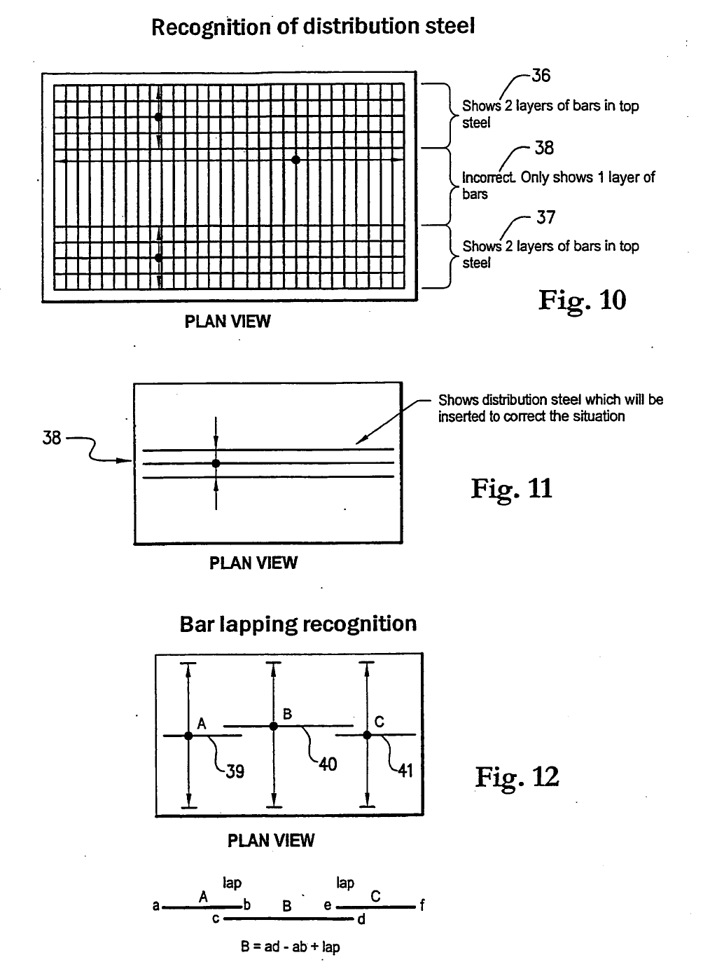

Recognition of missing secondary reinforcing bars, referred to as distribution steel, is another reinforced product property recognised by the database engine 12. Distribution steel is required when an area of bars in one layer of the reinforced concrete product does not have corresponding bars in an adjacent layer to ensure the layers are held in place when the concrete is poured. As seen in FIG. 10, two regions 36 and 37 of the reinforced concrete product include two layers of reinforcing bars in the uppermost layer. However, an intermediate zone 38 only shows one layer of bars on the engineering drawing. As seen in FIG. 11, the database engine 12 recognises the missing layer of bars in the zone 38 and determines that distribution steel is required to be inserted in that zone 38.

The reinforced product properties recognised by the database engine 12 also includes positions where one or more reinforcing bars overlap. To make allowance for the various bar lap length requirements required by the diameter of the reinforcing bars. For example, a lapped length requirement for an N16 bar is traditionally 600 mm, whilst that of an N20 bar is 800 mm. However, in situations where an N16 bar laps that of an N20 bar, the lap length requirement reverts to the smaller length of 600 mm. The detection of bar lapping positions between bars 39, 40 and 41 is shown in FIG. 12.

In the engineering drawings, the depictions of overlapping bars in a plan view of a reinforced product are generally not to scale. If we consider the example of the three N16 bars lapping end to end in a confined slab, namely in a slab where the first bar will start at the edge of the slab (less the edge cover), the second bar will lap the first bar by 600 mm and the third bar will lap the end of the second bar by 600 mm and terminate at the opposite end of the slab (again less the required edge cover), to complete the reinforcing requirements.

In order to effectively determining correct reinforcing bar lengths, the following three constraints are taken into account by the database engine 12. Firstly, the bar marking process follows the rule of left to right, and top to bottom, this means that the calculation and bar marking process begins with the first bar, and when completed the second and subsequent bars are processed. Secondly, the exact bar lap positions are not critical, for example if a lap position occurs 100 mm either side of a designated point this variation is unlikely to effect the strength of the reinforced product. Thirdly, the depictions of bar laps in terms of their dimensional lengths for each bar diameter are rarely drawn to scale on an engineering drawing for intelligence gathering purposes by the database engine 12.

In order to obtain an accurate result, the database engine 12, firstly determines the extent of the concrete outline (less the slab cover at each end) to provide the dimensional constraints to work with. The database engine 12 then gathers intelligence from the bar range line, and text blocks such as “N16@200” provide bar diameter, required spacings and extent of the reinforcing bars.

The first bar length is then processed by the database engine 12, taking into account its scanned length less the cover of the first slab edge. The second bar is then processed by the database engine 12 by determining its scanned end point, namely where the end of the second bar finishes minus the length of the first bar, plus the lap length which is required to join the two bars. The third bar is then processed by the database engine 12 by starting with the scanned end point of the second bar (which is known in relation to the starting slab edge position, less the end cover) then deducting this position from the end slab edge position, less the end cover, then adding the lap length requirement to the length requirement to the length of the third bar to enable it to successfully lap the second bar.

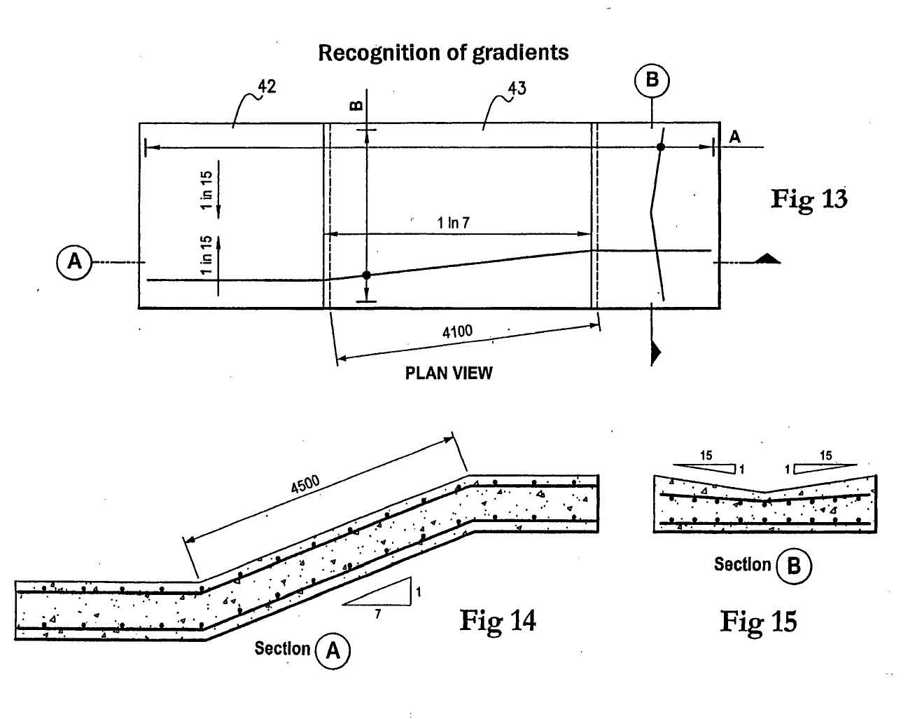

The database engine 12 also recognises the reinforced product property of the gradient of one or more portions of the reinforced product. Gradients or slopes in one or more directions can impact upon both the shape of reinforcing bars used as well as their true length. The slope of such gradients may be expressed on an engineering drawing in terms such as “one in fifteen” or “one in seven”, etc. Alternatively, the gradient of one or more portions of the reinforced product may be derived from the outline of the relevant portion of the reinforced product depicted on the engineering drawing. In these instances, whilst the confines of the slab or other reinforced product, being its extent as viewed in plan, may have a certain length, application of the ratio of the gradient will change the calculated length of the slab and hence the overall length of the reinforcing bars required to be used. In some instances, the shape of the bars required will also be changed by the gradient. FIGS. 13 to 15 illustrate three views of the same reinforced product including a gradient of one in fifteen in a first portion 42 and a gradient of one in seven in a second portion 43.

The database engine 12 allows for the automatic bar marking of all depictions of reinforcing bars shown in each layer throughout an engineering drawing or fenced area, which saves a considerable time of what is currently a time consuming aspect of reinforcing bar scheduling. Furthermore, the database engine 12 provides a faster and more efficient means of updating a bar mark range under circumstances where changes or revisions of the engineering drawings are required. It also allows for dissemination of the exact position of the bar mark to be inserted on the engineering drawing. This is achieved by utilising the conjunction point of where the bar depiction crosses the bar range line on the engineering drawing. The exact position at which the bar marking is inserted is determined by parameters maintained in the parameters database 14. Once the bar marks have been applied to the range of bars on the engineering drawing, an operator is able to manually adjust the positions of any bar marks which may be superposed or otherwise clash in order to ensure that each bar marking is clearly legible.

In that regard FIG. 16 depicts the conjunction point 44 at the intersection of a depicted bar 45 and a bar range line 46. The position of the bar mark 47 is initially determined by the database engine 12, as shown in FIG. 17, according to a parameter maintained in the parameters database 14, although this position may be manually altered by an operator to the final position of the bar mark 47 as shown in FIG. 18. FIG. 19 shows the bar label 49 finally applied at the selected position 48.

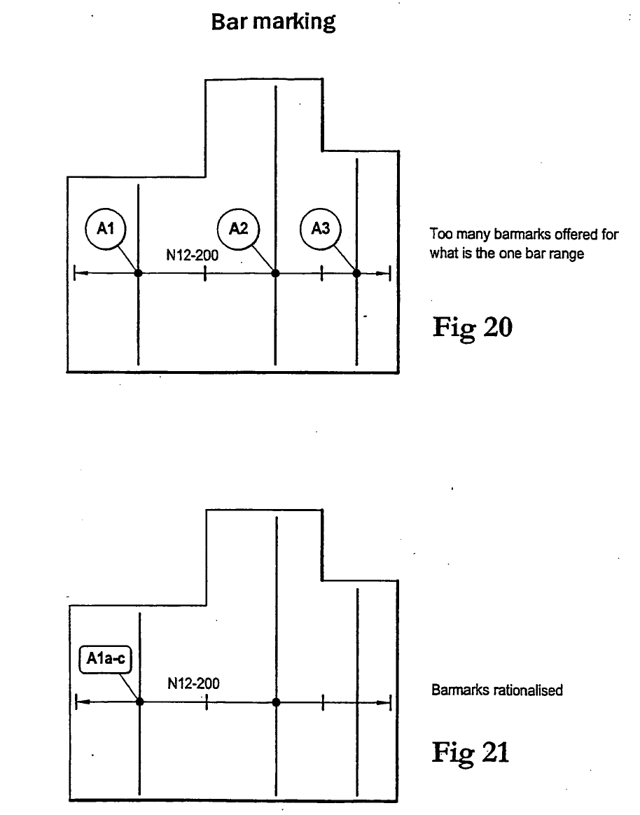

A distinct range of bars may feature a combination of different length and shaped bars. The database engine 12 indicates the bar ranges being of the same diameter and spacing, and spread across the slab in the extent indicated by the delimiter. However, as this range of bars follows the concrete outline of the reinforced product, the length of the reinforcing bars may change. Moreover, as the reinforcing bars encounter steps or stair positions, the shape of the reinforcing bars may in fact change. In these situations, the database engine 12 identifies and marks depictions of reinforcing bars in separate groups, such as the groups A1, A2 and A3 depicted in FIGS. 20 and 21.

Distribution steel is required when an area of bars in one layer of the reinforced products does not have a corresponding layer of bars in an adjacent layer in order to be the two layers together when concrete is poured. The database engine 12 highlights this missing steel and enables the distribution steel to be included in the scheduling operations. Notes provided on the engineering drawings nominate bar diameter and spacings required for areas requiring distribution steel, including lap lengths to be applied. After identifying areas requiring distribution steel, the database engine 12 in fills the zones requiring distribution steel by applying nominated bar diameter and spacings, and extending the lengths of such in fill bars so as to lap any existing bars. In cases of confined areas on one or both sides of the reinforced product, the inserted bars lengths are determined by the database engine 12 from the outer concrete outlines (less end cover) and including laps to adjacent bars if appropriate.

The database engine 12 recognises where steps or changes in slabs occurs and applies this information to the distribution steel located in those zones, for example by applying default requirements should the bars require an RC1 shape or bars of varying lengths should the concrete outline vary. Typically, once the distribution bars are calculated, they are inserted onto the engineering drawing, given an appropriate bar mark and spacing information then the pre-existing bar marks are updated to account for these new bars.

This process is demonstrated in FIGS. 22 to 24. FIG. 22 depicts a plan view of a reinforced product and includes depiction of four reinforcing bars 50 to 53, as well as lines 54 to 57 respectively indicating the extent of these bars. However, the database engine 12 determines that missing secondary reinforcing bars are required and are not depicted in FIG. 23. The missing secondary reinforcement bars 58 are depicted in FIG. 22. Accordingly, the database engine 12 updates the engineering drawing to include depictions 59 to 62 of the length and extent of the bars used in the secondary reinforcement, as seen in FIG. 24.

The database engine 12 also enables two methods for the reduction of the number of bar marks, and thus separate bundles of bars to be scheduled. As shown in FIG. 25, in a first rationalisation method, an operator uses the keyboard 17, mouse 18 and display 16 to access the database engine 12 and manually identify and highlights similar bars to a specified tolerance. Similar bars may be those bars that are considered by the operator to be alike in terms of bar diameter, shape and length which are desired to be grouped together under a single bar mark and bundle. These bars may have occurred in different locations throughout the slab and hence may have been nominated as different bars with different bar marks.

For example, the bars illustrated in FIG. 25 include bar markings 63, 64 and 65 respectively indicating A6×20 bars, 10×15 bars and a 29×15 bars. However, whilst these bars occur in different locations they are to all intents and purposes the same bar, namely an N20×3000 long bar. In order to rationalise the bars, an operator is able to select each of the bars indicated by the bar marks and activate a “collect function”. The database engine 12 then relabels each of the bars as a 6 and recalculates the quantity of these bars as 50 bars. The database engine 12 then relabels each of the bar marks on the engineering drawing to read a 6[20] a 6[15] and a 6[15] in those specific locations where the bar numbers occur. The amended bar marks 66 to 68 are shown in FIG. 26 after the rationalisation process.

In a variation of the foregoing, the database engine 12, having firstly read the bar marks, automatically determines which bars have characteristics falling within a limited band of tolerance, and automatically performs the “collect function” for these selected bars.

An operator is also able to edit the electronic engineering drawings maintained in the electronic drawings database 13 to insert bars and manipulate the bar shape, diameter, length and extent. In this regard, the database engine 12 causes to be displayed to the user a display element 69 shown in FIG. 27. The display element 69 includes a depiction of a bar crossed by a delimiter. The display element 69 is dropped onto an existing engineering drawing, as shown in FIG. 28. The operator is then able to manipulate the bar length, shape, range and spacings text, as indicated by the text box 70 shown in FIG. 28 in the final engineering drawing.

The database engine 12 further enables colour coding of the bars for each layer of steel in different colours. The bars change to a specific colour designated for that layer of steel as they are dealt with or as calculations are complete to highlight their status with each layer.

If the bundle rationalisation is invoked, the bars identified by either of the two methods change to an alternate colour different to that used by either of the two layers. For instance, if the colour selected for “LAYER A” is yellow and the colour selected for “LAYER B” is green, then the bars identified by the “Bundle Rationalisation Process” turn red. After grouping bars identified as being worthy of rationalisation, the process is complete, and those bars would revert back to the colour selected for that layer. Similarly, the process of inserting bars or distribution steel would revert to the alternate colour until the process is complete.

Any grouping of bars which the user highlights for further attention, also changes to the alternate colour until turned off. Likewise, as a user scrolls through the SLAB+Scheduling Window viewing a particular bar, such as “A-36”, that particular bar as viewed on the screen in Plan, will change colour momentarily to highlight its position. It later changes back to that layers original colour as the user scrolls to the next bar mark for examination.

As previously mentioned, the parameters database 14 maintains the parameters used by the database engine 12 to generate reinforcing bar scheduling data. The reinforced product parameters stored in the parameters database 14 establish overriding influences for a specific area of work, including default values for slab cover bottom and top, bar lap lengths for various diameter reinforcing bars, default bar shapes and dimensions as required by the RCI bar shape. Default guideline parameters applying to L-shaped bars are also used by the database engine to force a change of reinforcing bar shape to a hook bar under certain conditions to enable the bars to fit within the slab. Bar check calculation requirements such as spacing criteria and type are also included within the reinforced product parameters.

Parameters are the many variable constraints which influence, override, and provide direction to the various applications, data collection and calculations, of the SLAB+program. They provide important opportunities for fine tuning the extent to which the many applications might be applied for calculating, scheduling, or supply purposes. These variations may be due to handling and safety limitations, product availability, drawing detail or special needs, national and/or industry accepted standards, or supply requirements for the differing areas of the project.

By way of illustration only, the parameters may include (in some embodiments of the invention):

(i) the Available Lengths of Reinforcing bars, with respect to each bar grade and diameter, giving consideration to the various stock lengths available for each of them, as well as the potential lengths provided off coil. Provision may be built in to easily extend the range for each of the grades and diameters, to account for state variations and/or special order lengths from the steel mill to maximise bar lengths for specific projects; and

(ii) the Potential Length for bars, being a minimum cut length up to a maximum cut length for each of the bar grades and diameters, both from stock lengths and off coil. Provision may be made to easily extend the product range for each of the grades and diameters, if later required.

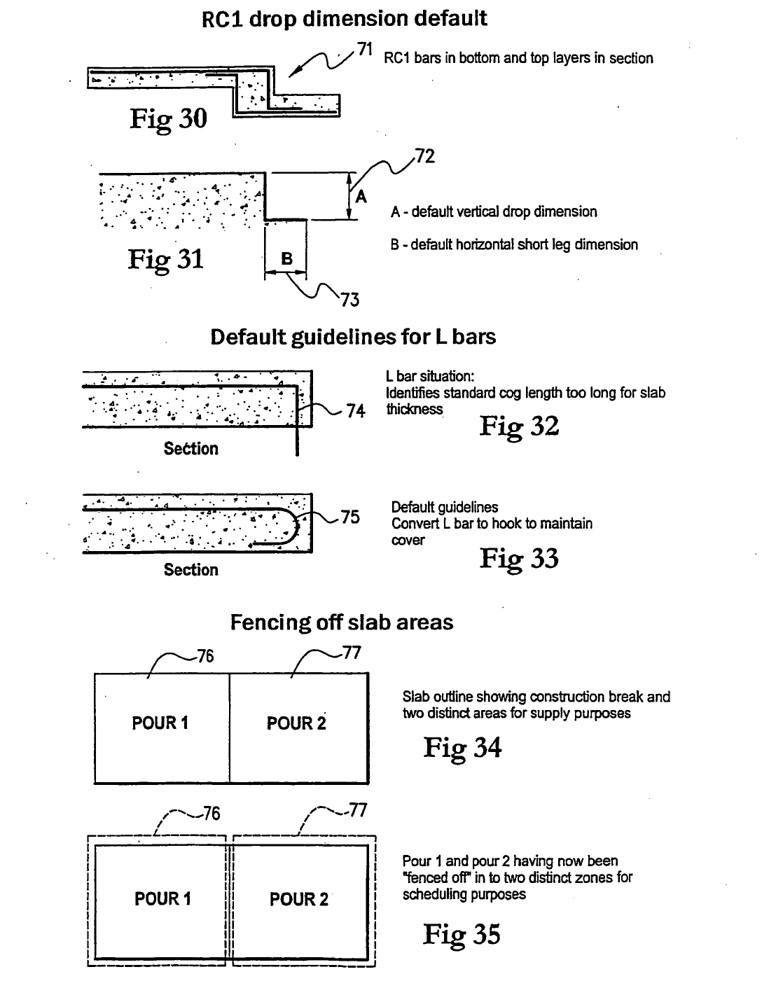

As seen in FIGS. 30 and 31, default guidelines are established, and defined in the reinforced product parameters, for RCI shaped bars, such as the bar reference 71, to enable predetermined default dimensions to be applied to both the vertical drop dimensions 72 and the horizontal short leg dimensions 73 of the bar 71.

Similarly, shape default guidelines are defined by the reinforced product parameters covering those instances when the scanning database 12 identifies an L-shaped bar which has a standard cog length too long to fit in the slab (as defined by slab thickness and cover requirements), such as the L-shaped bar 74 shown in FIG. 32. In this instance, the L-shaped bar is automatically changed by the database engine 12 to a hook bar 75 shown in FIG. 33 so that the slab cover guidelines, once again defined by the reinforced product parameters, are maintained. Other reinforced product parameters maintained in the parameters database 14 include factory constraints such as one third bundling rules, maximum bundle weight, and commercial bar lengths. A user is also able access the parameters maintained in the parameters database 14 via the database engine 12 in order to modify selected parameters.

A user is able to select one or more zones within an engineering drawing to carryout the reinforcing bar scheduling process. As seen in FIG. 34, the need to “fence off” an area for scheduling purposes may occur for a number of reasons, such as a construction break occurring in a large slab necessitating two distinct areas of supply, or the separation of internal slabs from balconies for supplying and bundling purposes. The user is able to cause the database engine 12 to fence off a first area 76 to be scheduled during a first scheduling process. A second area 77 is subsequently able to be scheduled.

The database engine 12 also enables modification of the engineering drawings maintained in the electronic drawings database 13, so that any area of a slab, and its associated information, can be redefined. The modification may involve (i) extending, reducing or deleting the extent of a concrete outline, (ii) deleting, extending or changing the position of a opening or void (iii) changing the position of a step, reducing its extent or deleting it entirely, and (iv) updating the extent of a bar range, including range, bar diameters and spacings.

The reinforcing bar scheduling data generated by the database engine 12 from the stored reinforced product parameters and detected reinforced product characteristics is displayed in a “scheduling window” at the display 16, and printed at the printer 15. As shown in FIG. 36, the display in the “scheduling window” displays a line number 78, bar mark 79, remarks or texts area 86, bar quantity 81, bar spacing 82, bar diameter 83, shape code 84 and shape depiction field 85. The operator is able to update or modify information appearing in this window. Not only is the operator able to change the data, but the operator can also change the Schedule window itself. A further requirement occurs when the bar spacing on the drawing nominated as, for example, N16@200 is required to be changed. By changing the spacing in the scheduling window to, for example N16@300, then the database engine 12 recalculates the extent of bars at the new spacing, updates the quantity and marks the engineering drawing maintained in the electronic drawings database 13 according to the new spacing requirement.

FIGS. 36 to 38 illustrate three examples of the reinforcing bar scheduling data displayed in the scheduling window. Automation of the scheduling process by use of the database engine 12 and associated parameters database 14 and electronic drawings database 13, can also be carried through to the calculation of reinforcing accessories. Utilising drawing intelligence derived from an engineering drawing by the database engine 12, such as the total area in square metres, the extent of the slab covered by various slab thicknesses, cover requirements, the extent with various diameter bars lap in two layers in relationship to the slab thickness they occur in (for example having two N12 bars lapping as compared to two N20 bars lapping) requires different bar chair heights to comply to top cover requirements. The derived drawing intelligence enables the database engine 12 to determine suitable bar chair requirements for a reinforced product.

The database engine 12 applies the existing intelligence information coupled with the data entry parameters to achieve the following calculations:
BTM STEEL CHAIR CALCULATIONS=given area in square metres×bar chair spacing×bottom cover requirements=number off bar chairs and type.
TOP STEEL CHAIR CALCULATIONS=given area in square metres×slab thickness in millimetres×two bar diameters lapping in relation to slab thickness—top cover—two bars lapping×bar chair lapping=number off bar chairs and type

Once the bar chair calculation is complete, the calculating data may be provided by the database engine 12 in a format such as:
Chair Height Required, being the calculation height is 169 mm
Chair Height Selection, being BCPT160, i.e. as cover requirements must be maintained, the database engine 12 round the choice down to the next available bar chair, in this case a BCPT160. However, being able to view the selection offers a user an override option—in this case he may determine that the 1 mm encroachment on top cover of say, 40 mm, it may not be advantageous to increase K to 49 mm.
Calculated Bar Chair Numbers Required, appear on the display 16, of say, 310 off BCPT30, alongside the SUPPLY NUMBER of 400 off BCPT30 (as this type of chair is supplied in bags of 100 the calculation would be rounded up for supply purposes). Having this information before you enables updates if required, i.e. the scheduler may not feel that the extra 10 chairs warrants supplying an extra bag, or the client may have some leftovers from a previous delivery.

There are instances when a slab thickness is too high thus requiring the use of rebar top hats to support the top layers of bar. A top hat support 86 is illustrated in FIG. 39 for use in the concrete slab 87. Top hats utilise an HL bar shape. Sometimes top hats are supplied in lieu of bar chairs due to the heavy weight of the top steel. Top hats traditionally rest upon the top of the second lowermost layer or B layer in the slab and beneath the second topmost layer, or C layer of the slab and usually have a lacer bar tied to the top of the top hat which facilitates laying out of the C layer of bars.

To calculate the height of the top hats, the diameters of bars in each of the four layers is considered by the database engine 12 for example the A, B, C and D layers may each be 20 mm bars. Assuming the lacer bar 12 mm, the bottom cover is 30 mm and top cover is 25 mm, the slab's thickness is 600 mm.

The following information is processed by the database engine 12 to determine the height of the top hats: (slab) 600 mm−25 mm (top cover)−40 mm (top layer D and C bars)−12 mm (lacer bar)−40 mm (bottom B and A bars)−30−mm (bottom cover)=balance of 453 mm rounded down to 450 m high top hats.

The process of determining top hats and lacer bars, and the numbers required involves data input of such requirements as: bar diameter and spacing of top hats (which would determine lacing bar positions), also bar diameter of lacing bars and whether stock 6 m, or cut to size lengths for lacer bars are required. FIG. 40 indicates the location of top hat positions as determined by chosen spacing, whereas FIG. 41 indicates location of lacing bars located over top hat positions.

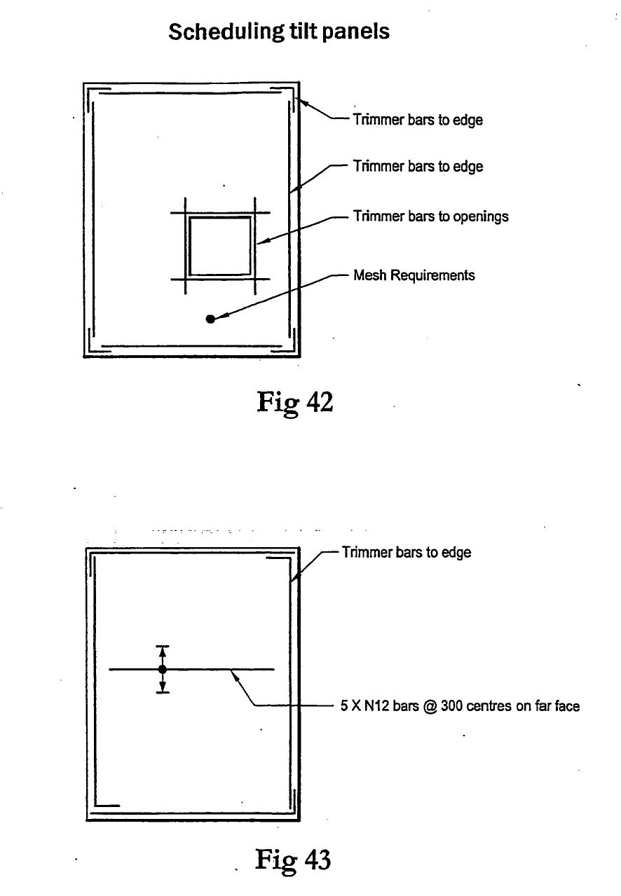

The above described system is also able to schedule tilt panels efficiently by entering panel dimensions and locations of openings, panel thicknesses, cover requirements, reinforcing requirements of mesh type, trimmer bars and any additional bars into the system framework. This results in complete schedules covering all bars with mesh and chair requirements calculated. Once again, the database engine 12 derives drawing intelligence from engineering drawings to obtain the following information:
panel size dimensions of height, width, thickness and any openings
reinforcing location requirements, for instance, the panel may have reinforcing centrally located on both faces
the identifiable faces of the panel, being its “near face” and “far face” to help determine bar chair type and heights, including cover requirements
reinforcing mesh requirements including the extent of mesh to each face should bar/mesh combinations be required
extent of reinforcing trimmer bars to the edge of panels
each type of information derived from scanner intelligence obtained by the database engine 12 is illustrated in FIGS. 41 and 42.

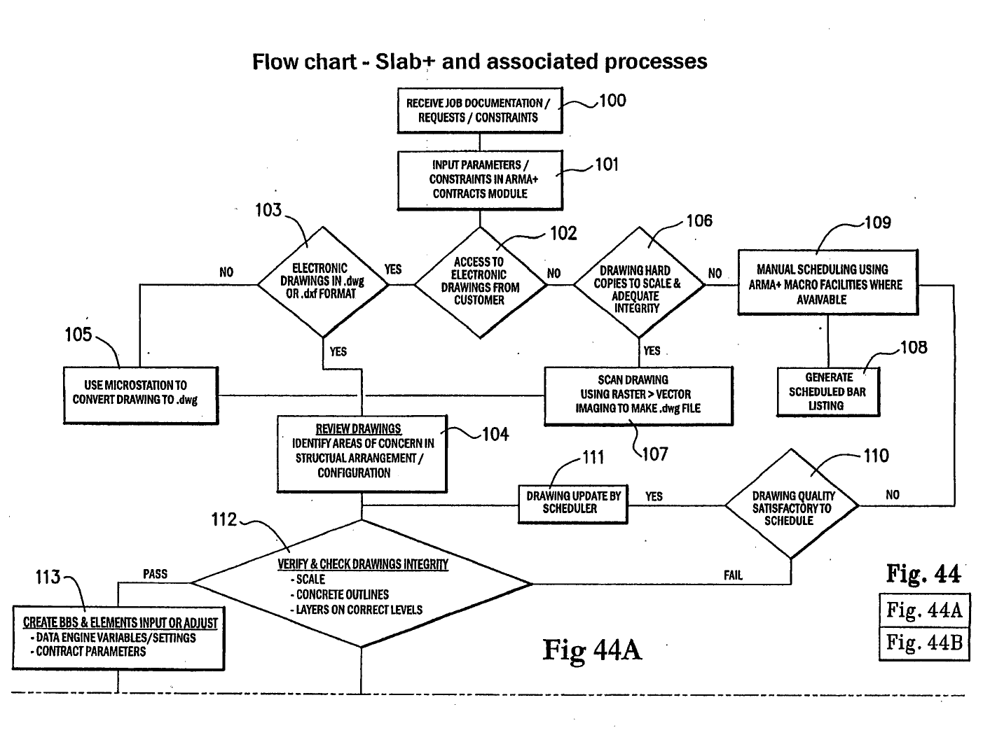

FIG. 43 provides an overview of the scheduling process performed by the scheduling system 10 shown in FIG. 1. Initially, at step 100, a scheduler receives job documentation, including various project requests and constraints. At step 101, these parameters and constraints are entered by the scheduler into the parameters database 14 via the database engine 12. If, at step 102, it is determined that electronic drawings have been provided by a customer, then, if it is determined at step 103 that the electronic drawings are in a .dwg or .dxf format, then those electronic drawings are reviewed at step 104 by the scheduler. If the electronic drawings are not in an appropriate format, the drawings are converted at step 105 into an appropriate format at a local workstation. If the drawings are not in electronic format, if it is determined at step 106 that the drawings are to scale and of adequate integrity, then, at step 107, the hard copy drawings are converted into a .dwg file by using raster to vector imaging. If drawings are not to scale or of adequate integrity, a schedule bar listing and manual scheduling are performed at steps 108 and 109. If it is determined that the drawing quality is satisfactory to schedule at 110, the drawing is updated by a scheduler at step 111. At step 112, the scheduler verifies and checks the integrity of drawings, notably to determine whether the drawings are to scale, whether the concrete outlines are correctly drawn, and layers are determined to be on the correct level. If the verification and checking process fails, then the drawing is again updated by the scheduler. However, if the drawing passes the verification and checking stage, the reinforced product parameters are created at step 113. At step 114, a selected area of the engineering drawing to be scheduled is highlighted or “fenced”, as shown in FIGS. 33 and 34.

At step 115 the database engine 12 acts to derive scanning intelligence from the electronic drawing, notably by detecting concrete outlines (top and bottom), bar quantity and diameter (text recognition), and distribution steel requirements. Once all scanning intelligence has been derived by the database engine 12 and the scheduler has made whatever manual interventions and modifications are required to the electronic engineering drawings, the database engine 12 uses the stored parameters 14 to effect further modification to the electronic engineering drawings, for example by carrying out bar bundle rationalisation modification of reinforcing bar shapes and application to default dimensions to the various reinforcing bars required. At step 116, the reinforcing bar scheduling data is generated in the form of the tabular information illustrated in FIGS. 35 to 37. At step 117, further rationalisation of bar bundles occurs. At step 118 a determination is made as to whether any additional manual scheduling update is required. If so, modification of the schedule data displayed to the scheduler is carried out at step 119.

Subsequently, if it is determined at step 120 that another area or zone of the electronic drawing is to be scheduled, then steps 114 to 119 are repeated. Otherwise, final bar marks are allocated, the electronic version of the engineering drawing updated and the reinforced bar scheduling listing is confirmed at step 121. The finalised form of the engineering drawings and the reinforcing bar schedule listing is then printed for subsequent use.

Whilst the majority of the work is typically carried out by the database engine 12 in the drawing file (*.dwg), it is preferable that the original drawing elements remain unchanged. Any additions to the drawing should preferably be done on a newly created layer that will be generated by the database engine 12. For example all bar marks might be placed on a new layer called “Bar marks”. These layers will be able to be changed by the user to be called a different name or select a different colour. The user to suit the drawing file may customise any of the attributes of the newly created layer.

Reinforced product parameters where needed can be refined or changed by the user at the drawing level to allow for a certain area. An example may be where the lap lengths are constant for the entire job except for one slab where the N12 lap is to be 800 mm. These lap lengths will be carried down from the contract level down to the drawing level where the user can then change only the N12 lap to 800 mm.

Concrete Outline

The database engine 12 recognises multiple parts of the drawing that should also be initiated in the drawing setup (parameters). Within this area the user is able to set

Layers that will form the concrete outline

Concrete outline/s

Steps/folds in the top of slab

Steps/folds in the bottom of slab

Voids

Layers that indicate a concrete joint

Areas to allocate covers, lapping requirements and RL's

Text parameters

Layers that define bars

Layers that define bar ranges

Bar/bar range bisector

Lapping indicator

Default colours

Concrete Outline/s

The database engine 12 recognises a variety of shapes (polygons, polylines, circles, ellipses, etc) that will form the concrete outline. This is done by recognising layers. During setup, the user will need to select layers that form the concrete outline. This may involve more than a single layer depending on the drawing file and its creator.

Steps/Folds in Slab

Steps in the top or bottom of slab can also selected by layer. These will also have a corresponding RL (reduced level) associated with them. There may also be instances when a step line will have multiple RL's associated with it in the case where there is a sloping step line. Steps in the soffit are generally indicated shown as a broken line (dashed).

Voids

Voids can also be treated as a concrete outline as there is to be no bars penetrating an area where a void exists. With this in mind when allocating voids to areas there will also be a need to indicate which area. For example there may be a slab with a rectangular void in the centre. The user will be prompted to indicate where the void is (inside the rectangle or outside the rectangle).

Layers that Indicate a Concrete Joint

A concrete joint will indicate that there is to be some termination of bars. This termination may be where all bars finish within the area being scheduled (like a concrete face), or they may penetrate a certain length (lap length) past the joint Lines that indicate a concrete joint will generally be a different linetype to other lines.

Areas to Allocate Covers, Lapping Requirements and RL's

Areas will be used to define certain parameters. One function will enable the user to click in areas that will then invoke a table will set cover. This table contains the following:

Slab condition—Whether the area is a slab or support

Bottom RL

Top RL

Covers—this will include more than one cover. (top, bottom, side and so on).

The database engine 12 will then fill the area around the click with the required information.

This method can also be used to indicate what is to happen with laps. There is to be two choices for setting lap requirements. Bars often lap in to a beam a certain distance (nominally 12 bar diameters but may be indicated by a dimension per diameter). This distance will need to be set in the parameters. By clicking in a beam area and then nominating that area a “support” the database engine 12 will then lap the required distance. Likewise at a step, a bar may have a full lap (40 bar diameters) to the bar at the lower or upper level. Again this will be set in the defaults area. Then by clicking in a step thickening area and nominating it as a “slab”, the database engine 12 will know that a bar will need to lap the required distance of 40 bar diameters.

Text Parameters

The database engine 12 also provides a place to define settings for text, as well as a “search area” to enable the software to search in a predetermined area for the location of the necessary text. Here the database engine 12 may ask the user to click on a bar description. When the user clicks on the text the program may ask for the user to explain the text. An example follows below.

43N12-300—text that is displayed on drawing

Users will then convert text to represent different parameters

43N12-300

43—Represents quantity

N—Represents bar grade

12—Represents bar diameter

-—Represents nothing

300—Represents bar spacing

The database engine 12 recognises any of the text attributes including fonts, heights, thickness and justification. This then ensures that the database engine 12 is able to recognise any text that the creator of the drawing may have used.

Likewise if a slab indicates its bar spacing and diameter with a single letter this functionality can also be utilised by the following:

V—text that is displayed on drawing

Scheduler then indicates the following

V—represents grade N, diameter 12, spacing 250.

Layers that Define Bars

Bars will generally be drawn on a layer where all of the bottom bars are drawn on a layer (e.g. Btm_bars) and all of the top bars are drawn on a separate layer (e.g. Top_bars). There will therefore still be a need to select multiple layers to define bars. The easiest way to define a layer is to tell the database engine 12 that you want to select a layer to represent bars. The user will then click on the bar and the database engine 12 will use that lines properties (layer) to define the bars for the rest of the drawing. A shape catalogue is used by the database engine 12 to recognize the bar shapes.

Since bars are generally shown in the form of a mat, the database engine 12 will require the user to indicate what bar direction is to be scheduled. This will allow bar marks to be allocated to bars in the correct direction. The database engine 12 can also act to apply bar marks and directions for more than one layer of bars and have the software work with both simultaneously. An exemplary screen display 200 explaining the laying sequence of the bars and hence the scheduling sequence also is illustrated in FIG. 45.

Layers that Define Bar Ranges

Bar Ranges can be drawn on a layer where all of the bottom bar ranges are drawn on a layer (e.g. Btm_range) and all of the top bar ranges are drawn on a separate layer (e.g. Top_range). There is therefore still be a need to select multiple layers to define bar ranges. There are also scenarios where the extent lines are in a different layer from the delimiter. To define bar ranges, the user does the following:

Clicking on the lines indicated by the reference numeral 201 in FIG. 46 to define the bar range extents.

Clicking on the line indicated by the reference numeral “202” in FIG. 46 to define the delimiter.

Clicking on the circle indicated by the reference numeral “203” in FIG. 46 to define the bisector. This is explained in more detail below.

Clicking on the ellipse indicated by the reference numeral “204” in FIG. 46 to define the lapping indicator. Again, this is explained in more detail below.

When the user clicks on the above-mentioned entities, the database engine 12 will use those entities properties (layer, colour, radius) to define these elements for rest of the drawing. For example, once the user has clicked indicated by the reference numeral 201, the database engine 12 then recognises these range extent lines on the entire drawing. If these entities happen to be on the same layer as the bar, this will not matter because the range extents will all be the same length and they can therefore be ignored as bars.

There may also be occasions where a range break is indicated. This will generally take the form as another bar range extent line. This will then tell the software that the bar range changes in some way. The same spacing will be applied unless there is another text note between the range break and the next range break. The range break will generally indicate a bar will change shape as shown in the exemplary screen display 210 shown in FIG. 47.

Bar/Bar Range Bisector

It is also desirable to choose the bisector that intersects the bar with the bar range as indicated in the picture above at “3”. This may take the form of a circle as shown or as other entities including donuts (filled circles). It is important for the database engine 12 to recognise these entities as there may be bars passing through several range lines. These bisectors will denote which range the bar belongs to.

Lamping Indicator

There are bars on a drawing depicted in such a way that they lap to another bar and consequently do not have a bar range of there own. There will be a need to default the database engine 12 to search for an object that will indicate this scenario. These indicators take many forms but are basic shapes. One such scenario is FIG. 46 by the reference numeral 204. When the database engine 12 is told that this is a lapping indicator, this will apply to the remainder of that drawing. In doing so, the database engine 12 will then know that the bar without a bar range is the same grade, diameter, spacing and covers the same extents as the bar that it is lapped to. It is important for the bars not to exceed the concrete structure with the exception in the case of a concrete joint perhaps.

If there are multiple bars lapping, the database engine 12 will extract the info from the bar that has the information. As can be seen from the exemplary screen display 220 in FIG. 48, it would be necessary for the bar on the extreme right to extract information from the bar it is lapped to. Since this bar is also lapped to another bar and consequently does not have the relevant information, the software must look further. The database engine 12 then looks to the next bar, which does happen to have the information required. In turn this information will then be passed along to the bars that are lapped to this bar.

Default Colours

Advantageously, the software uses colour to bring entities to the attention to of the user. This will highlight errors, problems or indicate the status of the drawing. While the software will have default colours that are used, it is also important that the user can customise these colours. It is envisaged that the user will have the following set as colours:

Concrete outline—When the user is selecting the layers for the concrete outline it is expected that any current outlines will be made distinguished.

Bars—When the user selects the typical bar to be used by clicking on it, it is expected that the software will then highlight all bars in that direction one colour and all the bars in the second direction a different colour.

Bar Ranges—When the user selects the typical bar range to be used by clicking on the necessary entities, it is expected that the software will then highlight all bar ranges visible on the screen.

Scheduling—When the software has scheduled a bar and consequently the bar appears in the scheduling window, it is expected that the software will then show this bar and bar range as a different colour, which is different from the unscheduled bars. This will distinguish between what has been scheduled and what has not been scheduled.

Scheduling Window—As the user scrolls through the line by line in the scheduling window, it is expected that the bar with the dynamic link to that line will be highlighted as each line is scrolled through. If the user is to double click on a line in the scheduling window, it is expected that the bar that has the dynamic link with that line will be zoomed in to the centre of the screen and be made a different colour to the remaining bars. This will allow the user to easily see where this bar is located and change it if necessary.

### Scheduling Window

The scheduling window is to show the details of the bars that have been scheduled. This will include all of the headings of the scheduling screen with the addition of bar spacing. The user should be able to hide columns (e.g. Pin and type of work) that they do not wish to see. They should also be able to change the order of which the columns appear in the scheduling window. The scheduling window will be a floating toolbar but it should also be able to be docked if the user desires. The overall size of the window will be adjustable by clicking and dragging the edges of the window in the desired direction. Users will be able to sorted ascending or descending information within each heading by clicking on the column heading.

There should also be the ability to make multiple selections within the window. For example if the user wants to delete five bar marks, they will highlight the five lines and hit delete.

Dynamic Link between WRS and DWG

It is expected that if information is changed in the scheduling window, this will then be adjusted in the drawing. For example, if there was a bar 3 metres long and the user changed it to 5 metres long, the bar would extend 2 metres. As the software would not know which direction to extend the bar, we see that the user will then click on the side of the bar they wish to extend. If the user changes the bar spacing in the scheduling window, the quantity of bars will change. If the user inserts a bar in the scheduling window, the bar will then be attached to the mouse cursor waiting for the user to place the new bar in the drawing. If the user does not want the new bar to appear on the actual drawing for some reason (too messy), they can click somewhere out of the way so that the drawing remains unchanged. There should also be the function to have the new bar placed on the concrete outline but not have the bar print on any marking plans.

It will be appreciated that the database engine 12 includes a processing device and associated memory for storing a computer program element for causing operation of the processing device. The computer program element includes a series of instructions for causing the processing device to carry out the above described computerised method of scheduling reinforcing bars for use in reinforced products.

Existing scheduling products are developed for the purpose of creating architectural and structural drawings and so during the detailing of these drawings the scheduled bar data is generated. However, the present invention provides the ability and flexibility to extract scheduled data from already existing structural drawings supplied from customers.

One existing product can convert existing CAD elements into scheduled bar data but nevertheless requires manually selection of the line or lines, one at a time to produce scheduled data for one bar. The scheduled data is then determined by the length of the lines drawn and you also have to manually specify the bar diameter, quantity and bar mark number for the bar using a ‘form bar’ function. This is a very slow and manual orientated process, which also relies on accurately drafted drawings, which are very rare.

In at least one embodiment, the present invention is firstly able to define a set of rules such as nominating concrete levels, reinforcement levels, default concrete cover, etc and then activate a scan function that will scan for bars within the whole detail or part thereof. The scan function will determine what is a concrete line and what is a reinforcement line and then generate scheduled data based on the scanned information. Bar lengths are automatically adjusted based on the concrete cover rules to compensate for inaccurate detailing. Bar diameters and quantities are also automatically assigned, as the scanning process will have text recognition that reads the existing text labels. At the end of the scanning process a separate dynamic detail for a bar marking plan is produced as well as the scheduled data.

Finally, it is to be understood that various modifications and additions may be made to the invention without departing from the spirit or ambit of the invention.

1. An automated method of scheduling reinforcing bars for use in reinforced products, the method including the steps of:
storing default reinforced product parameters in a database;
receiving in electronic form one or more drawings containing reinforced product properties including one or more characterisations for at least one reinforcing bar in the reinforced product;
in a database engine, reading said drawing(s) including said characterisation(s) in the drawings, thereby detecting said reinforced product properties including said one or more characterisations for at least one reinforcing bar in the reinforced product; and
using the stored reinforced product parameters and detected reinforced product properties to generate reinforcing bar scheduling data.

2. A method according to claim 1, wherein the reinforced products include reinforced concrete products, including any one or more of a concrete slab, beam, column, wall, stair, tilt panel, coupler, top hat, bar chair and laser bar.

3. A method according to claim 1, wherein the reinforced product properties include any one or more of the outline of the reinforced product, the extent of the reinforced product and any penetrations of the reinforced product.

4. A method according to claim 1, wherein the reinforced product properties include steps in one of more surfaces of the reinforced product, including any visible and hidden steps in the reinforced product.

5. A method according to claim 1, wherein the reinforced product properties include text characterising one or more of the reinforcing bars.

6. A method according to claim 5, wherein the text characterises the dimensions of reinforcing bars or the spacing between reinforcing bars.

7. A method according to claim 6, wherein the reinforcing bar dimensions include any one or more of shape, length and position within a layer of the reinforced product.

8. A method according to claim 1, wherein the reinforced product properties include the shape of one or more of the reinforcing bars.

9. A method according to claim 1, wherein the reinforced product properties include the extent of one or more ranges of the reinforcing bars.

10. A method according to claim 1, wherein the reinforcing bars include primary reinforcing bars or secondary reinforcing bars, such as distribution steel.

11. A method according to claim 1, wherein the reinforced product properties include data characterising the secondary reinforcing bars.

12. A method according to claim 1, wherein the reinforced product properties include positions where one or more reinforcing bars overlap.

13. A method according to claim 1, wherein the reinforced product properties include the gradient of one or more portions of the reinforced product.

14. A method according to claim 1, wherein the default reinforced product parameters include the bottom or top cover of the reinforced product.

15. A method according to claim 1, wherein the default reinforced product parameters includes bar overlap lengths.

16. A method according to claim 1, wherein the default reinforced product parameters include default bar shapes or dimensions.

17. A method according to claim 1, the method further including the step of:
selecting one or more zones within the one or more reinforced product drawings to carry out reinforcing bar scheduling.

18. A method according to claim 17, wherein each zone corresponds to separately constructed portion of the reinforced product.

19. A method according to claim 18, wherein at least one separately constructed portion is a separately poured section of a reinforced concrete product.

20. A method according to claim 1, the method further including the step of:
at a display terminal, displaying the reinforcing bar scheduling data.

21. A method according to claim 1, the method further including the step of:
rationalising the reinforcing bars for use in the reinforced products.

22. A method according to claim 21, wherein the step of rationalising the reinforcing bars includes:
selecting reinforcing bars having dimensions within a predefined tolerance; and
re-labelling the selected reinforcing bars within the same dimensions on the reinforced product drawings.

23. An automated system for scheduling reinforcing bars for use in reinforced products, the system including:
a database for storing default reinforced product parameters; and
a database engine for reading one or more reinforced product drawings and automatically detecting one or more reinforced product properties, including one or more characterisations for at least one reinforcing bar in the reinforced product, wherein the database engine uses the stored reinforced product parameters and detected reinforced product properties to schedule reinforcing bars for use in reinforced products in accordance with claim 1.

24. A computer program element for use in a computerised system for scheduling reinforcing bars for use in reinforced products, the computer program element including a series of instructions for causing a database engine to:
receive in electronic form one or more drawings containing reinforced product properties including one or more characterisations for at least one reinforcing bar in the reinforced product;
reading said drawing(s) including said characterisation(s) in the drawings, thereby detecting said reinforced product properties including said one or more characterisations for at least one reinforcing bar in the reinforced product; and
using the reinforced product parameters stored in a database, and the detected reinforced product properties, to generate reinforcing bar scheduling data.
